(19) United States
(12) Patent Application Publication
(10) Pub. No.: US 2018/0210836 A1
(43) Pub. Date: Jul. 26, 2018

(54) THERMAL AND RELIABILITY BASED CACHE SLICE MIGRATION

(71) Applicant: Microsoft Technology Licensing, LLC, Redmond, WA (US)

(72) Inventors: Patrick P. Lai, Fremont, CA (US); Robert Allen Shearer, Woodinville, WA (US)

(21) Appl. No.: 15/414,540

(22) Filed: Jan. 24, 2017

(51) Int. Cl. G06F 12/0864; G06F 12/0811

(52) U.S. Cl. CPC G06F 12/0864; G06F 2212/62; G06F 12/0811

(57) ABSTRACT

A multi-core processing chip where the last-level cache is implemented by multiple last-level caches (a.k.a. cache slices) that are physically and logically distributed. The various processors of the chip decide which last-level cache is to hold a given data block by applying a temperature or reliability dependent hash function to the physical address. While the system is running, a last-level cache that is overheating, or is being overused, is no longer used by changing the hash function. Before accesses to the overheating cache are prevented, the contents of that cache are migrated to other last-level caches per the changed hash function. When a core processor associated with a last-level cache is shut down, or processes/threads are removed from that core, or when the core is overheating, use of the associated last-level cache can be prevented by changing the hash function and the contents migrated to other caches.

### BACKGROUND

Integrated circuits, and systems-on-a-chip (SoC) may include multiple independent processing units (a.k.a., “cores”) that read and execute instructions. These multi-core processing chips typically cooperate to implement multiprocessing. To facilitate this cooperation and to improve performance, multiple levels of cache memories may be used to help bridge the gap between the speed of these processors and main memory.

### SUMMARY

Examples discussed herein relate to an integrated circuit that includes a plurality of last-level caches. These last-level caches be placed in at least a first high power consumption mode and a first low power consumption mode. The plurality of last-level caches include a first cache and a second cache. The integrated circuit also includes at least a first temperature sensor that generates a first temperature indicator that is associated with a temperature of the first cache. A plurality of processor cores on the integrated circuit access data in the plurality of last-level caches according to a first hashing function. This first hashing function maps processor access addresses to at least the first cache and the second cache. Based at least in part on the first temperature indicator, the plurality of processor cores access data in the plurality of last-level caches according to a second hashing function that maps processor access addresses to a subset of the plurality of last-level caches that does not include the first cache. An interconnect network receives hashed access addresses from the plurality of processor cores and couples each of the plurality of processor cores to a respective one of the plurality of last-level caches specified by the hashed access addresses generated by a respective one of the first and second hashing function.

In an example, a method of operating a processing system having a plurality of processor cores includes, based at least in part on a first temperature indicator associated with a first cache of a first set of last-level caches of a plurality of last-level caches meeting a first threshold criteria, mapping, using a first hashing function, accesses by a first processor core of the plurality of processor cores to the first set of last-level caches. The method also includes, based at least in part on a second temperature indicator associated with the first cache of the first set of last-level caches of the plurality of last-level caches meeting a second threshold criteria, mapping, using a second hashing function, accesses by a first processor core to a second set of last-level caches that does not include the first cache.

In an example, a method of operating a plurality of processor cores on an integrated circuit includes distributing accesses by a first processor core to a first set of last-level caches of a plurality of last-level caches using a first hashing function. The first processor core being associated with a first last-level cache of the plurality of last-level caches. Accesses by a second processor core are distributed to the first set of last-level caches using the first hashing function. The second processor core being associated with a second last-level cache of the plurality of last-level caches. Based at least in part on a temperature indicator associated with at least one of second processor core and the second last-level cache, accesses by the first processor core are distributed to a second set of last-level caches using a second hashing function that does not map accesses to the second last-level cache.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

In order to describe the manner in which the above-recited and other advantages and features can be obtained, a more particular description is set forth and will be rendered by reference to specific examples thereof which are illustrated in the appended drawings. Understanding that these drawings depict only typical examples and are not therefore to be considered to be limiting of its scope, implementations will be described and explained with additional specificity and detail through the use of the accompanying drawings.

FIG. 1A is a block diagram illustrating a processing system.

FIG. 1B is a diagram illustrating an example distribution of accesses to last-level caches by a first hashing function.

FIG. 1C is a diagram illustrating an example distribution of accesses, by a second hashing function, that avoids an over-temperature or over-used last-level cache.

FIG. 1D is a diagram illustrating an example distribution of accesses, by a second hashing function, that avoids a last-level cache based on a temperature of an associated processor core.

FIG. 1E is a diagram illustrating an example process of migrating cache entries so that a second cache hashing function can be used by the system.

FIG. 2A illustrates a first cache hashing function that distributes accesses to all of a set of last-level caches based on temperature indicators.

FIG. 2B illustrates a second cache hashing function that distributes accesses to a subset of the last-level caches based on temperature indicators.

FIG. 3 is a flowchart illustrating a method of operating a processing system having a plurality of last-level caches.

FIG. 4 is a flowchart illustrating a method of operating a processing system having a plurality of processor cores.

FIG. 5 is a flowchart illustrating method of changing the distribution of accesses among sets of last-level caches.

FIG. 6 is a block diagram of a computer system.

### DETAILED DESCRIPTION OF THE EMBODIMENTS

Examples are discussed in detail below. While specific implementations are discussed, it should be understood that this is done for illustration purposes only. A person skilled in the relevant art will recognize that other components and configurations may be used without parting from the spirit and scope of the subject matter of this disclosure. The implementations may be a machine-implemented method, a computing device, or an integrated circuit.

In a multi-core processing chip, the last-level cache may be implemented by multiple last-level caches (a.k.a. cache slices) that are physically and logically distributed. The various processors of the chip decide which last-level cache is to hold a given data block by applying a hash function to the physical address. In an embodiment, while the system is running, a last-level cache that is (or is becoming) either overheated, or is being overused, is no longer used by changing the hash function. The last-level cache may be left powered-up while it cools, or it may be powered down. Before accesses to the overheating cache are prevented, the contents of that cache are migrated to other last-level caches per the changed hash function. In another embodiment, when a core processor associated with a last-level cache is shut down, processes/threads are removed from that core, or when the core is overheating, use of the associated last-level cache is prevented by changing the hash function and migrating the contents of the overheating cache to other caches. The contents of that cache are migrated to other last-level caches per the changed hash function.

As used herein, the term “processor” includes digital logic that executes operational instructions to perform a sequence of tasks. The instructions can be stored in firmware or software, and can represent anywhere from a very limited to a very general instruction set. A processor can be one of several “cores” (a.k.a., ‘core processors’) that are collocated on a common die or integrated circuit (IC) with other processors. In a multiple processor (“multi-processor”) system, individual processors can be the same as or different than other processors, with potentially different performance characteristics (e.g., operating speed, heat dissipation, cache sizes, pin assignments, functional capabilities, and so forth). A set of “asymmetric” or “heterogeneous” processors refers to a set of two or more processors, where at least two processors in the set have different performance capabilities (or benchmark data). A set of “symmetric” or “homogeneous” processors refers to a set of two or more processors, where all of the processors in the set have the same performance capabilities (or benchmark data). As used in the claims below, and in the other parts of this disclosure, the terms “processor”, “processor core”, and “core processor”, or simply “core” will generally be used interchangeably.

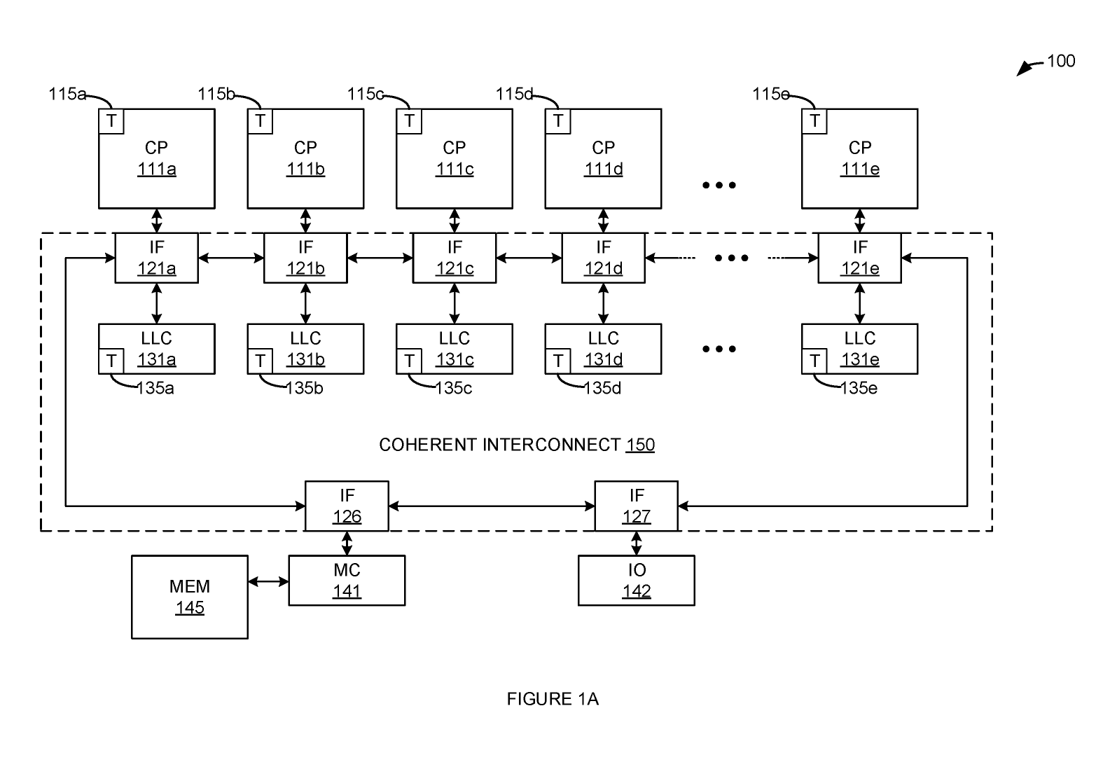

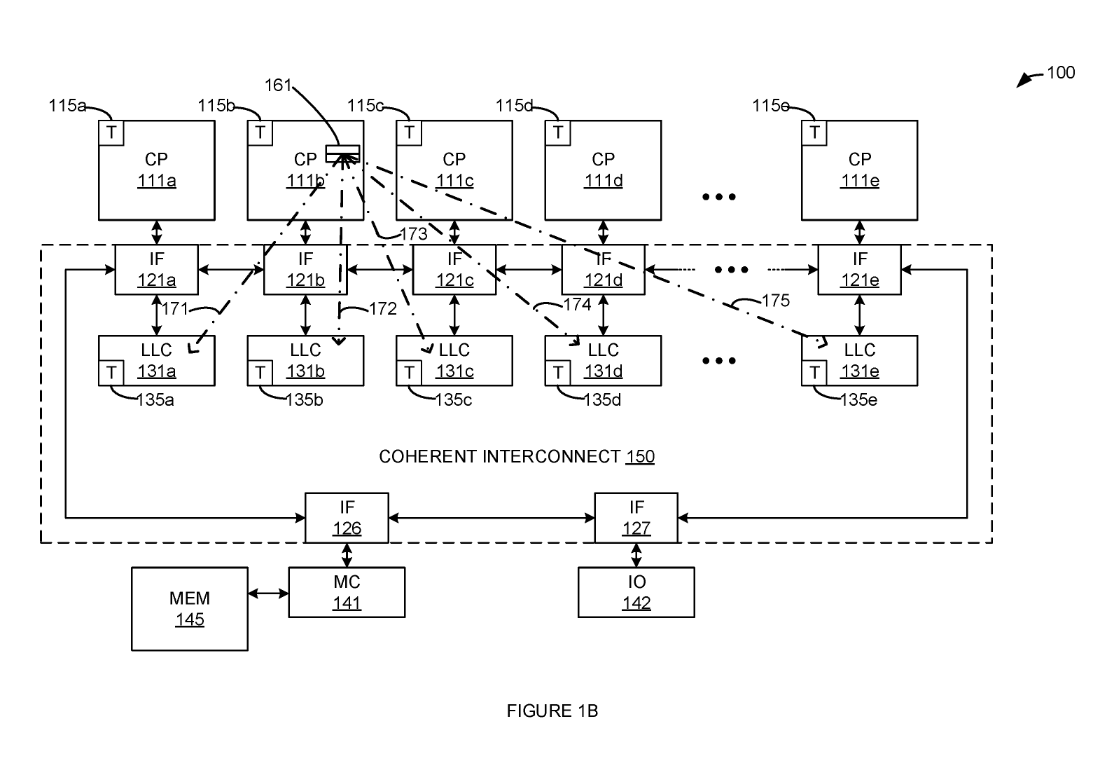

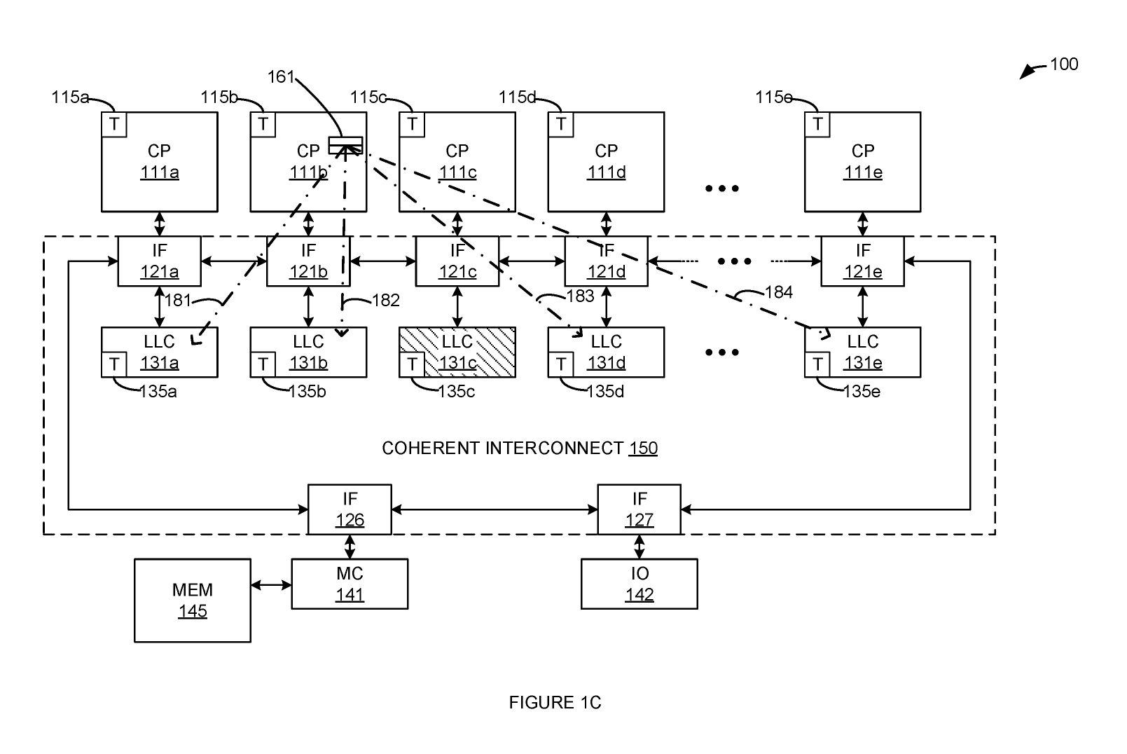

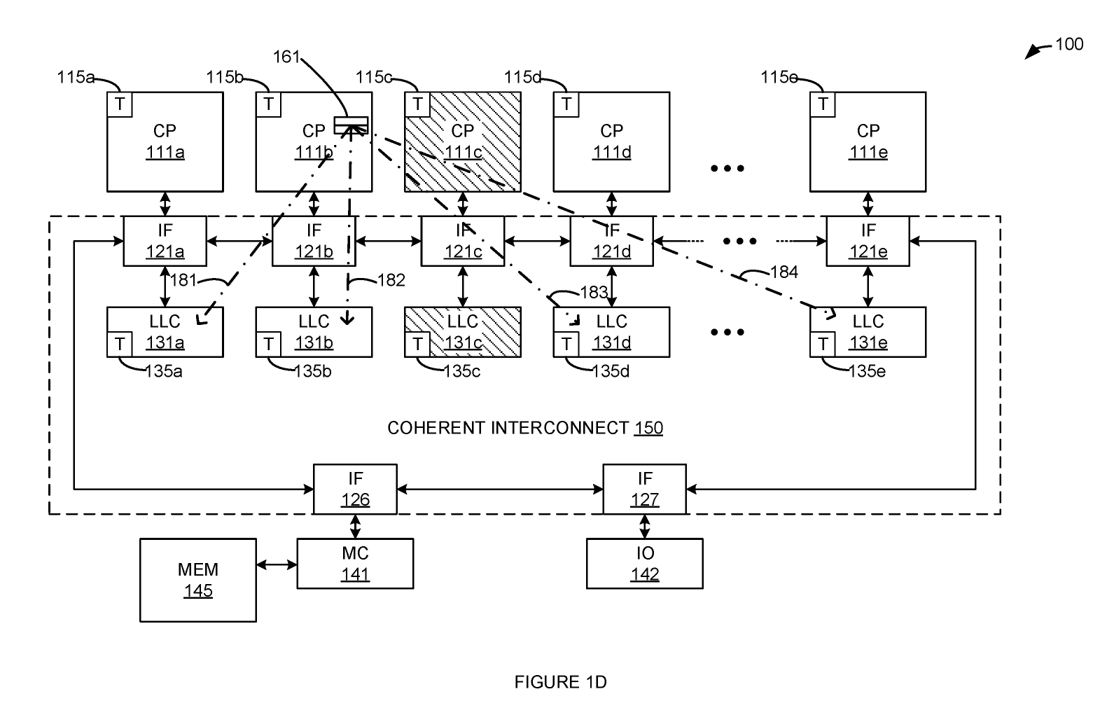

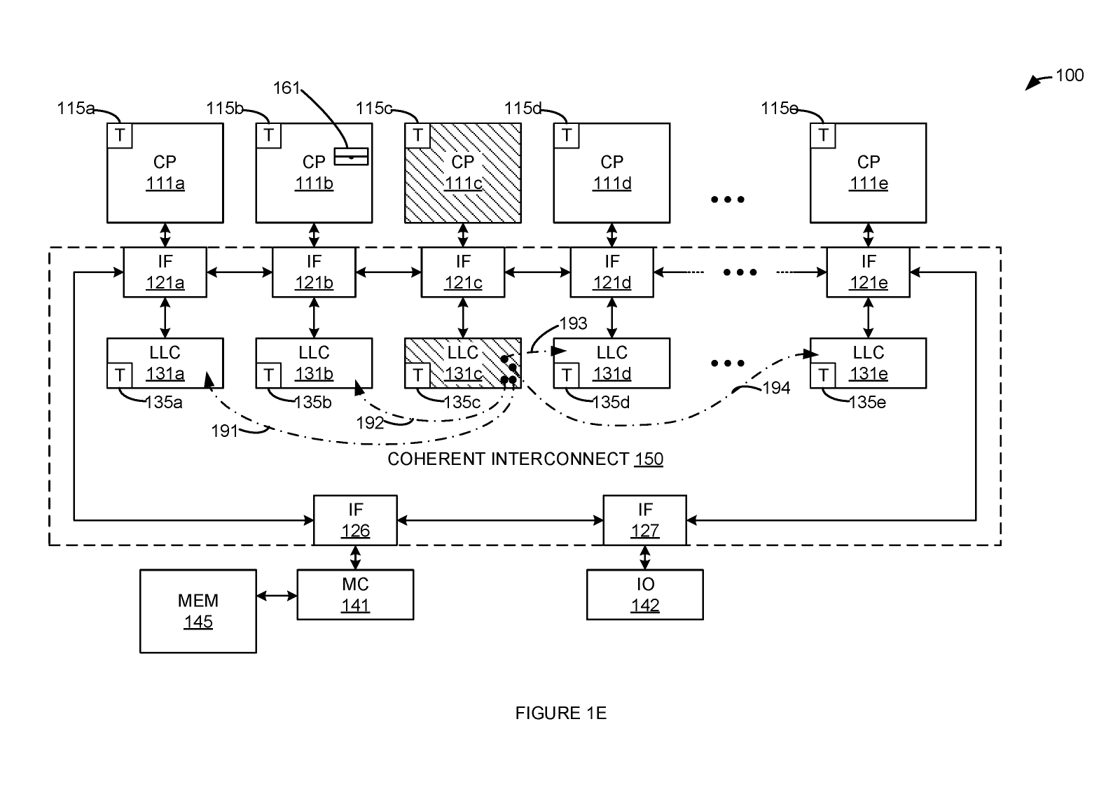

FIG. 1A is a block diagram illustrating a processing system. FIG. 1A is a block diagram illustrating a processing system. In FIG. 1, processing system 100 includes core processors (CP) 111a-111e, coherent interconnect 150, memory controller 141, input/output (IO) processor 142, and main memory 145. Coherent interconnect 150 includes interfaces 121a-121e, interfaces 126-127, and last-level caches 131a-131e. Processors 111a-111e respectively include, or are associated with, thermal sensors 115a-115e that provide thermal indicators of the temperature of the respective processor 111a-111e. Last-level caches 131a-131e respectively include, or are associated with, thermal sensors 135a-135e that provide thermal indicators of the temperature of the respective last-level cache 131a-131e. Processing system 100 may include additional processors, interfaces, caches, thermal sensors, and IO processors (not shown in FIG. 1.)

Core processor 111a is operatively coupled to interface 121a of interconnect 150. Interface 121a is operatively coupled to last-level cache 131a. Core processor 111b is operatively coupled to interface 121b of interconnect 150. Interface 121b is operatively coupled to last-level cache 131b. Core processor 111c is operatively coupled to interface 121c of interconnect 150. Interface 121c is operatively coupled to last-level cache 131c. Core processor 111d is operatively coupled to interface 121d of interconnect 150. Interface 121d is operatively coupled to last-level cache 131d. Core processor 111e is operatively coupled to interface 121e of interconnect 150. Interface 121e is operatively coupled to last-level cache 131e. Memory controller 141 is operatively coupled to interface 126 of interconnect 150 and to main memory 145. IO processor 142 is operatively coupled to interface 127.

Interface 121a is also operatively coupled to interface 121b. Interface 121b is operatively coupled to interface 121c. Interface 121c is operatively coupled to interface 121d. Interface 121d is operatively coupled to interface 121e—either directly or via additional interfaces (not shown in FIG. 1.) Interface 121e is operatively coupled to interface 127. Interface 127 is operatively coupled to interface 126. Interface 126 is operatively coupled to interface 121a. Thus, for the example embodiment illustrated in FIG. 1, it should be understood that interfaces 121a-121e, interface126, and interface 127 are arranged in a ‘ring’ interconnect topology. Other network topologies (e.g., mesh, crossbar, star, hybrid(s), etc.) may be employed by interconnect 150.

Interconnect 150 operatively couples processors 111a-111e, memory controller 141, and IO processor 142 to each other and to last-level caches 131a-131e. Thus, data access operations (e.g., load, stores) and cache operations (e.g., snoops, evictions, flushes, etc.), by a processor 111a-111e, last-level cache 131a-131e, memory controller 141, and/or IO processor 142 may be exchanged with each other via interconnect 150 (and, in particular, interfaces 121a-121e, interface 126, and interface 127.)

It should also be noted that for the example embodiment illustrated in FIG. 1, each one of last-level caches 131a-131e is more tightly coupled to a respective processor 111a-111e than the other processors 111a-111e. For example, for processor 111a to communicate a data access (e.g., cache line read/write) operation to last-level cache 131a, the operation need only traverse interface 121a to reach last-level cache 131a from processor 111a. In contrast, to communicate a data access by processor 111a to last-level cache 131b, the operation needs to traverse (at least) interface 121a and interface 121b. To communicate a data access by processor 111a to last-level cache 131c, the operation needs to traverse (at least) interface 121a, 121b and 121c, and so on. In other words, each last-level cache 131a-131e is associated with (or corresponds) to the respective processor 111a-111e with the minimum number of intervening interfaces 121a-121e, 126 and 127 (or hops) between that last-level cache 131a-131e and the respective processor 111a-111e.

In an embodiment, each of processors 111a-111e can distribute data blocks (e.g., cache lines) to last-level caches 131a-131e according to at least two cache hash functions. For example, a first cache hash function may be used to distribute data blocks being used by at least one processor 111a-111e to all of last-level caches 131a-131e. In another example, one or more (or all) of processors 111a-111e may use a second cache hash function to distribute data blocks to less than all of last-level caches 131a-131e.

Provided all of processors 111a-111e (or at least all of processors 111a-111e that are actively reading/writing data to memory) are using the same cache hash function at any given time, data read/written by a given processor 111a-111e will be found in the same last-level cache 131a-131e regardless of which processor 111a-111e is accessing the data. In other words, the data for a given physical address accessed by any of processors 111a-111e will be found cached in the same last-level cache 131a-131e regardless of which processor is making the access. The last-level cache 131a-131e that holds (or will hold) the data for a given physical address is determined by the current cache hash function being used by processors 111a-111e, memory controller 141, and IO processor 142. The current cache hash function being used by system 100 may be changed from time-to-time based on one or more temperature indicators. The current cache hash function being used by system 100 may be changed from time-to-time in order to reduce thermal hotspots and/or improve system reliability.

In an embodiment, when a thermal sensor 135a-135e die detects that a last-level cache 131a-131e is approaching or has exceeded a preset temperature limit (a.k.a. over-limit last-level cache 131a-131e), the accesses to that over-limit last-level cache 131a-131e are frozen (i.e., halted). The contents of that over-limit last-level cache 131a-131e are then migrated to at least one other last-level cache 131a-131e. Accesses that are or were originally heading to the over-limit last-level cache 131a-131e are rerouted to one or more of the other last-level cache 131a-131e by dynamically changing the cache hash function used by processors 111a-111e, memory controller 141, and IO processor 142. The whole process or freezing the over-limit last-level cache 131a-131e is done atomically without invoking and/or requiring an operating system reboot.

To migrate the contents from the over-limit last-level cache 131a-131e to at least one other last-level cache 131a-131e, system 100 is placed in a state where all accesses to all last-level cache 131a-131e are put on hold. In an embodiment, system 100 is placed in a quiescent state for the purpose of allowing all cache accesses to complete prior to suspending the accesses to last-level caches 131a-131e. Once any outstanding transactions to access last-level caches 131a-131e are committed, and any associated queues have been emptied, the contents of the over-limit last-level cache 131a-131e can be migrated to at least one other last-level cache 131a-131e.

It should be understood that if system 100 is placed in a quiescent state where all last-level caches 131a-131e are put on hold, the whole bandwidth of interconnect 150 can be dedicated to the migration process. Thus, in an embodiment, the duration of time taken to migrate the contents of the over-limit last-level cache 131a-131e is a function of the sustainable read bandwidth of the over-limit last-level cache 131a-131e and the sustainable write bandwidth of the one or more last-level cache 131a-131e that are receiving the contents of the over-limit last-level cache 131a-131e

In an embodiment, if program correctness can be maintained, only accesses to a limited (rather than the whole) address space may be put on hold. For example, system 100 may only hold accesses to the physical memory space mapped to the over-limit last-level cache 131a-131e and the one or more last-level cache 131a-131e that are to receive the contents of the over-limit last-level cache 131a-131e. In other words, an embodiment may allow accesses to the portion(s) of the physical address space not related to the over-limit last-level cache 131a-131e and the one or more last-level cache 131a-131e that are receiving the contents of the over-limit last-level cache 131a-131e.

After the migration of the contents of the over-limit last-level cache 131a-131e is complete, the hash function can be modified. Once the cache hash function used by processors 111a-111e, memory controller 141, and IO processor 142 is changed, all accesses to the physical memory space that was mapped to the over-limit last-level cache 131a-131e would be currently be mapped to the other last-level caches 131a-131e. The modification of the hashing function should be atomic and should be performed in a manner that will not break program correctness of any running threads. After the hash function has been modified, accesses to last-level caches 131a-131e (except the over-limit last-level cache 131a-131e), and normal operation, can be resumed.

The process of migrating of the contents of the over-limit last-level cache 131a-131e can either be independent of process migrations between processors 111a-111e originated by the operating system, or can be performed in conjunction with a process migration off of a processor 111a-111e. In an embodiment, a processor core 111a-111e that has became a thermal hotspot (e.g., a thermal sensor 115a-115e detects an over-limit condition associated with a processor 111a-111e) is also creating a thermal hotspot in an adjacent last-level cache 131a-131e. In this case, both the process(es) running on the over-limit processor 111a-111e and the contents of the last-level cache 131a-131e associated with the over-limit processor 111a-111e may be migrated at the same time. In an embodiment, the contents of the last-level cache 131a-131e associated with the over-limit processor 111a-111e are migrated along with the process(es) even though the temperature sensor 135a-135e for that last-level cache 131a-131e does not indicate an over-limit condition.

In an embodiment, once the thermal hotspot associated with the over-limit last-level cache 131a-131e and/or the over-limit processor 111a-111e meets one or more conditions (e.g., thresholds) that indicate a within-limits operating temperature, a specific segment of the physical address space may be assigned to reactivate the (previously) over-limit last-level cache 131a-131e to improve overall system performance. In an embodiment, system 100 may elect to migrate a least-used segment of memory to the (previously) over-limit last-level cache 131a-131e thus reducing the power and time consumption required to perform the atomic migration and hash function modification procedure as described herein.

Thus, it should be understood that system 100 is able to dynamically configure the physical-address to last-level cache 131a-131e mapping (hashing) to alleviate thermal hotspots. System 100 is also able to dynamically configure the physical-address to last-level cache 131a-131e mapping (hashing) to reduce repeated uses of a particular portion of the silicon (i.e., a particular last-level cache 131a-131e, or particular cache line entries therein) thereby improving the reliability and/or lifetime of system 100.

In an embodiment, last-level caches 131a-131e can be placed in at least a high power consumption mode and a low power consumption mode. Temperature sensors 135a-135e generate temperature indicators that are associated with the temperature of the respective caches. For example, temperature sensor 135c may generate, over time, a series of temperature indicators that are associated with the temperature of last-level cache 131c. Processor cores 111a-111e access data in last-level caches 131a-131e according to a first hashing function that maps processor 111a-111e access addresses to at least last-level cache 131c and at least one other last-level cache 131a-131b, 131d-131e (e.g., last-level cache 131b.)

Based on an indicator received from temperature sensor 135c, processors 111a-111e switch to a second hashing function that maps access addresses such that last-level cache 131c is not accessed. For example, based on a temperature indicator from temperature sensor 135c showing an over-limit condition, processors 111a-111e switch to a second hashing function that maps access addresses such that last-level cache 131c is not accessed. The second hashing function may be such that the set of accessed last-level caches is, for example, last-level caches 131a-131b and last-level caches131d-131e—but not last-level cache 131c. Interconnect 150 receives hashed access addresses from processors 111a-111e and to couples processors 111a-111e to the respective last-level cache 131a-131e specified by the hashed access addresses generated by a respective one of the first and second hashing function.

In an embodiment, a temperature indicator from a processor core 111a-111e is used as the trigger for a second hash function. For example, based at least in part on temperature indicator from temperature sensor 115c that is associated with the temperature of processor 111c, processor cores 111a-111e are to access data in last-level caches 131a-131e according to a second hashing function that maps processor 111a-111e access addresses to a last-level caches 131a-131b and last-level caches 131d-131e—but not last-level cache 131c. Processor cores 111a-111e may stop accessing data in last-level caches 131a-131e while the contents of last-level cache 131c are transferred to, for example, last-level cache 131b.

Processor cores 111a-111e may also stop accessing data in a second cache while contents of the first cache are transferred to the second cache. For example, processor cores 111a-111e may stop accessing data in last-level cache 131c while the contents of last-level cache 131c are transferred to, for example, last-level cache 131b (and/or other last-level caches 131a, 131d-131e.)

In an embodiment, one or more of processor cores 111a-111e is still be able to access data in a last-level cache that is not receiving the contents of the first cache while the contents of the first cache are transferred to the second cache. For example, processor cores 111a-111e may access last-level cache 111a while contents of last-level cache 111c are transferred to last-level cache 111b.

FIG. 1B is a diagram illustrating an example distribution of accesses to last-level caches by a first hashing function. In FIG. 1B, processor 111b uses a (first) cache hash function that distributes accessed data physical addresses 161 to all of last-level caches 131a-131e. This is illustrated by example in FIG. 1B by arrows 171-175 that run from accessed data physical addresses 161 in processor 111b to each of last-level caches 131a-131e, respectively.

FIG. 1C is a diagram illustrating an example distribution of accesses, by a second hashing function, that avoids an over-temperature or over-used last-level cache. In FIG. 1C, based on a temperature indicator from temperature sensor 135c and/or temperature sensor 115c, processor 111b uses a (second) cache hash function (different from the first cache hash function illustrated in FIG. 1B) that distributes the same accessed data physical addresses 161 to only last-level caches 131a-131b and last-level caches131d-131e—but not last-level cache 131c. This is illustrated by example in FIG. 1C by arrows 181-184 that run from accessed data physical addresses 161 to each of last-level caches 131a-131b and last-level caches131d-131e, respectively—and the lack of arrows from data 161 to last-level caches 131c.

FIG. 1D is a diagram illustrating an example distribution of accesses, by a second hashing function, that avoids a last-level cache based on a temperature of an associated processor core. In FIG. 1D, based on a temperature indicator from temperature sensor 115c, processor 111b uses a (second) cache hash function (different from the first cache hash function illustrated in FIG. 1B) that distributes the same accessed data physical addresses 161 to only last-level caches 131a-131b and last-level caches 131d-131e—but not last-level cache 131c. This is illustrated by example in FIG. 1D by arrows 181-184 that run from accessed data physical addresses 161 to each of last-level caches 131a-131b and last-level caches131d-131e, respectively—and the lack of arrows from data 161 to last-level caches 131c.

FIG. 1E is a diagram illustrating an example process of migrating cache entries so that a second cache hashing function can be used by the system. In FIG. 1E, based on a temperature indicator from temperature sensor 135c and/or temperature sensor 115c, system 100 is placed in a quiescent state for the purpose of allowing all cache accesses to complete prior to suspending the accesses to last-level caches 131a-131e. Once any outstanding transactions to access last-level caches 131a-131e are committed, and any associated queues have been emptied, the contents of the over-limit last-level cache 131a-131e can be migrated to at least one other last-level cache 131a-131e. This is illustrated in FIG. 1E by arrows 191-194 running from last-level cache 131c to last-level caches 131a, 131b and 131e.

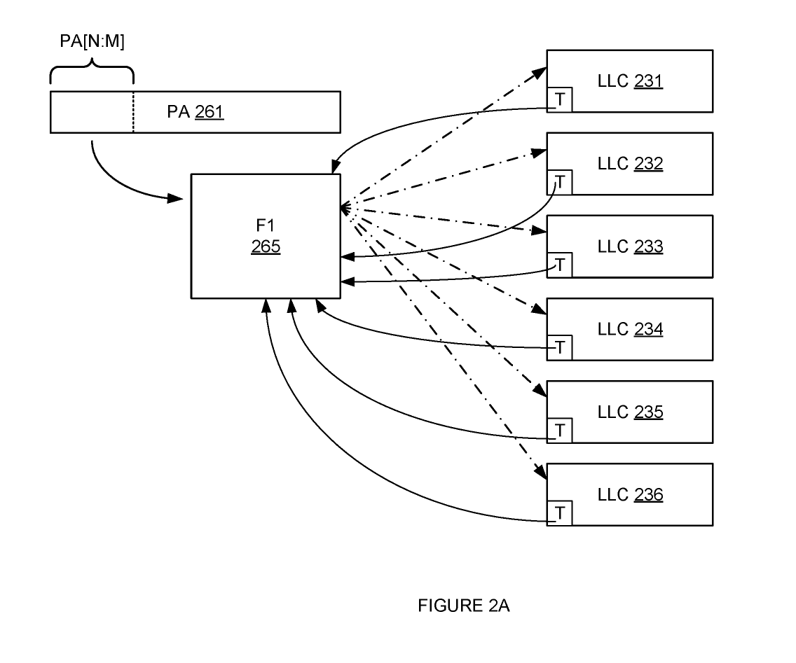

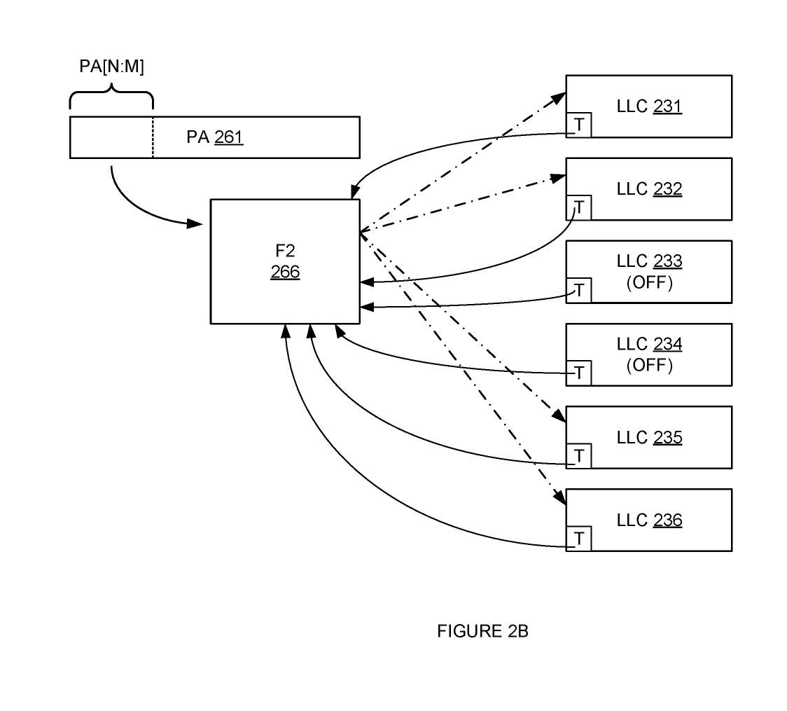

FIG. 2A illustrates a first cache hashing function that distributes accesses to all of a set of last-level caches based on temperature indicators. In FIG. 2A, a field of bits (e.g., PA[N:M] where N and M are integers) of a physical address PA 261 is input to a first cache hashing function 265. Cache hashing function 265 processes the bits of PA[N:M] in order to select one of a set of last-level caches 231-236. Cache hashing function 265 is dependent on temperature indicators from last-level caches 231-236. For example, if none of the temperature indicators from last-level caches 231-236 indicate an over-limit condition, cache hashing function 265 will be selected. Cache hashing function 265 processes the bits of PA[N:M] such that all of last-level caches 231-236 are eligible to be selected. The selected last-level cache 231-236 is to be the cache that will (or does) hold data corresponding physical address 261 as a result of cache function F1 265 being used (e.g., by processors 111a-111e.)

FIG. 2B illustrates a second cache hashing function that distributes accesses to a subset of the last-level caches based on temperature indicators. In FIG. 2B, a field of bits (e.g., PA[N:M] where N and M are integers) of the same physical address PA 261 is input to a second cache hashing function 266. Cache hashing function 266 processes the bits of PA[N:M] in order to select one of a set of last-level caches consisting of 231, 232, 235, and 236. Cache hashing function 266 is dependent on temperature indicators from last-level caches 231-236. For example, if the temperature indicators from last-level caches 233 and 234 indicate a over-limit conditions, and the temperature indicators from last-level caches 231, 232, 235, and 236 do not indicate an over-limit condition, cache hashing function 265 will be selected. Cache hashing function 266 processes the bits of PA[N:M] such that only last-level caches 231, 232, 235, and 236 are eligible to be selected. The selected last-level cache is to be the cache that will (or does) hold data corresponding physical address 261 as a result of cache function F2 266 being used (e.g., by processors 111a-111e.) Thus, while cache hashing function 266 is being used, last-level caches 633 and 634 may be turned off, placed in some other power-saving mode, or otherwise be allowed to cool.

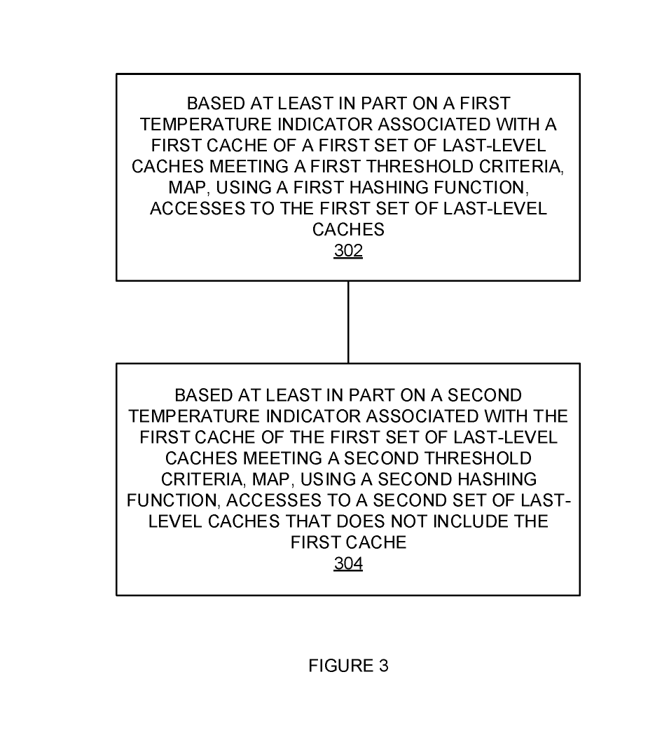

FIG. 3 is a flowchart illustrating a method of operating a processing system having a plurality of last-level caches. The steps illustrated in FIG. 3 may be performed, for example, by one or more elements of processing system 100. Based at least in part of a first temperature indicator associated with a first cache of a first set of last-level caches meeting a first threshold criteria, map, using a first hashing function, accesses to the first set of last-level caches (302). For example, when temperature indicators associated with all of last-level caches 131a-131e (e.g., including the indicator for last-level cache 131a) indicate a within-limits condition, processor 111a may map its accesses using a first hashing function that distributes these accesses to any and all of last-level caches 131a-131e.

Based at least in part on a second temperature indicator associated with the first cache of the first set of last-level caches meeting a second threshold criteria, map, using a second hashing function, accesses to a second set of last-level caches that does not include the first cache (304). For example, based at least in part on a temperature indicator associated with last-level cache 131a, processor 111a may map its accesses using a second hashing function that distributes these accesses only to those of last-level caches 131a-131e that are associated with temperature indicators that are not over a certain limit. In other words, when one or more of last-level caches 131a-131e are over-limit, processor 111a uses the second hashing function to avoid accessing those of last-level caches 131a-131e are over-limit.

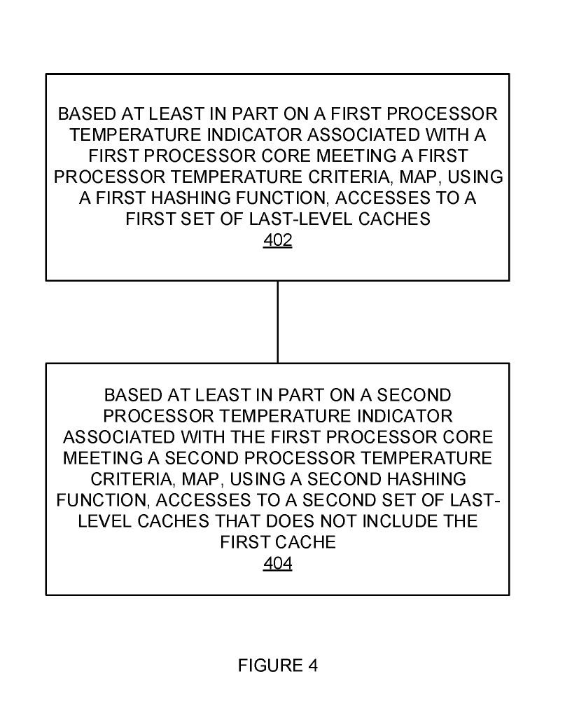

FIG. 4 is a flowchart illustrating a method of operating a processing system having a plurality of processor cores. The steps illustrated in FIG. 4 may be performed, for example, by one or more elements of processing system 100. Based at least in part of a first processor temperature indicator associated with a first processor core meeting a first processor temperature criteria, map, using a first hashing function, accesses to a first set of last-level caches (402). For example, when temperature indicators associated with all of processors 111a-111e (e.g., including the indicator for processor 111a) indicate a within-limits condition, processor 111b may map its accesses using a first hashing function that distributes these accesses to any and all of last-level caches 131a-131e.

Based at least in part on a second temperature indicator associated with the first cache of the first processor core meeting a second processor temperature criteria, map, using a second hashing function, accesses to a second set of last-level caches that does not include the first cache (404). For example, based at least in part on a temperature indicator associated with processor 111c, processor 111b may map its accesses using a second hashing function that distributes these accesses only to those of last-level caches 131a-131e that are associated with processors 111a-111e that are associated with temperature indicators that are not over a certain limit. In other words, when one or more of processors 111a-111e are over a temperature limit, processor 111b uses the second hashing function to avoid accessing those the last-level caches 131a-131e that are most tightly coupled to processors 111a-111e that are over-limit.

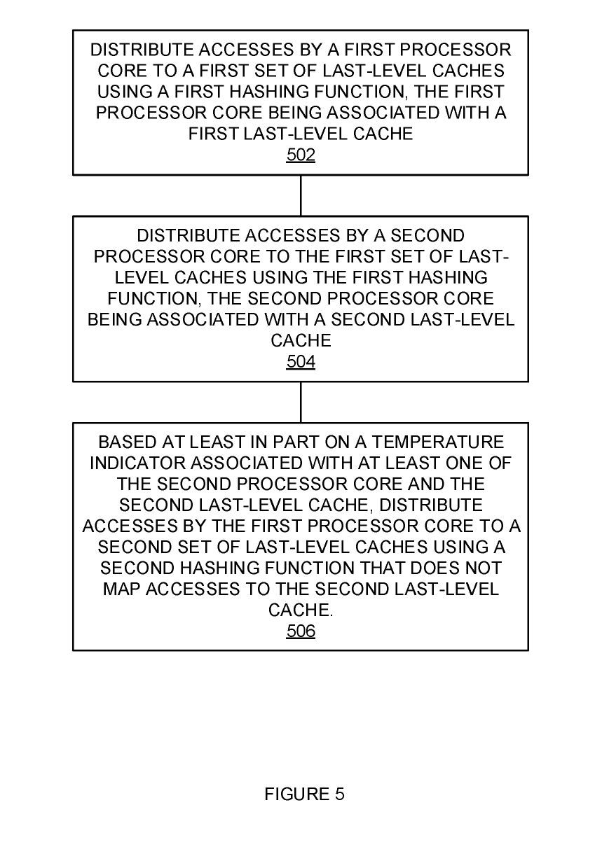

FIG. 5 is a flowchart illustrating method of changing the distribution of accesses among sets of last-level caches. The steps illustrated in FIG. 5 may be performed by one or more elements of processing system 100. Accesses by a first processor core to a first set of last-level caches are distributed using a first hashing function where the first processor core is associated with a first last-level cache (502). For example, processor 111a (which is associated with last-level cache 131a) may distribute accesses according to a first hash function that results in these accesses being distributed to any and all of last-level caches 131a-131e.

Accesses by a second processor core are distributed to the first set of last-level caches using the first hashing function where the second processor core is associated with a second last-level cache (504). For example, processor 111b (which is associated with last-level cache 131b) may distribute accesses according to a first hash function that results in these accesses being distributed to any and all of last-level caches 111a-111e.

Based at least in part on a temperature indicator associated with at least one of the second processor core and the second last-level cache, accesses are distributed by the first processor core to a second set of last-level caches using a second hashing function that does not map accesses to the second last-level cache (506). For example, based on a temperature indicator associated with processor 111b being over-limit, processor 111a may use a hashing function that does not distribute accesses to last-level cache 131b—which is most tightly coupled with processor 111b. Likewise, for example, based on a temperature indicator associated with last-level cache 131b being over-limit, processor 111a may use a hashing function that does not distribute accesses to last-level cache 131b.

The methods, systems and devices described herein may be implemented in computer systems, or stored by computer systems. The methods described above may also be stored on a non-transitory computer readable medium. Devices, circuits, and systems described herein may be implemented using computer-aided design tools available in the art, and embodied by computer-readable files containing software descriptions of such circuits. This includes, but is not limited to one or more elements of processing system 100 and its components. These software descriptions may be: behavioral, register transfer, logic component, transistor, and layout geometry-level descriptions.

Data formats in which such descriptions may be implemented are stored on a non-transitory computer readable medium include, but are not limited to: formats supporting behavioral languages like C, formats supporting register transfer level (RTL) languages like Verilog and VHDL, formats supporting geometry description languages (such as GDSII, GDSIII, GDSIV, CIF, and MEBES), and other suitable formats and languages. Physical files may be implemented on non-transitory machine-readable media such as: 4 mm magnetic tape, 8 mm magnetic tape, 3½-inch floppy media, CDs, DVDs, hard disk drives, solid-state disk drives, solid-state memory, flash drives, and so on.

Alternatively, or in addition, the functionally described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), multi-core processors, graphics processing units (GPUs), etc.

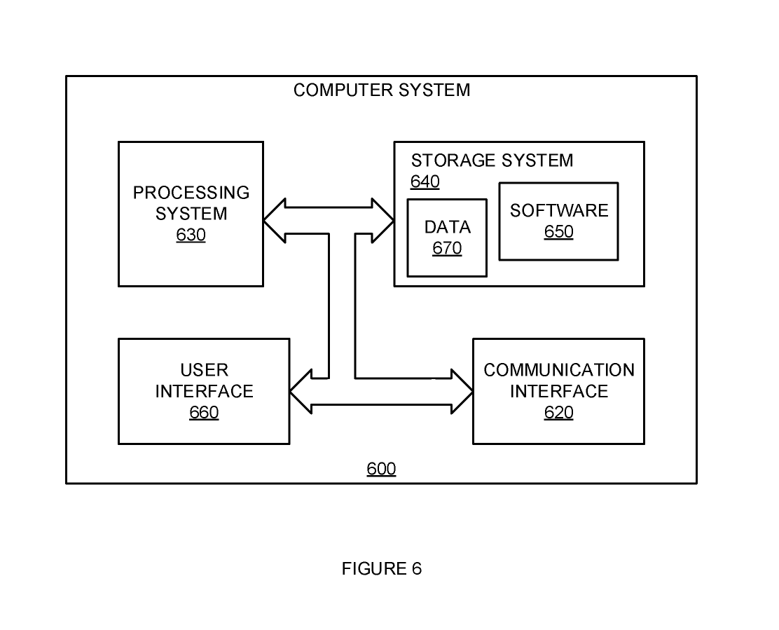

FIG. 6 illustrates a block diagram of an example computer system. In an embodiment, computer system 600 and/or its components include circuits, software, and/or data that implement, or are used to implement, the methods, systems and/or devices illustrated in the Figures, the corresponding discussions of the Figures, and/or are otherwise taught herein.

Computer system 600 includes communication interface 620, processing system 630, storage system 640, and user interface 660. Processing system 630 is operatively coupled to storage system 640. Storage system 640 stores software 650 and data 670. Processing system 630 is operatively coupled to communication interface 620 and user interface 660. Processing system 630 may be an example of processing system 100, and/or its components.

Computer system 600 may comprise a programmed general-purpose computer. Computer system 600 may include a microprocessor. Computer system 600 may comprise programmable or special purpose circuitry. Computer system 600 may be distributed among multiple devices, processors, storage, and/or interfaces that together comprise elements 620-670.

Communication interface 620 may comprise a network interface, modem, port, bus, link, transceiver, or other communication device. Communication interface 620 may be distributed among multiple communication devices. Processing system 630 may comprise a microprocessor, microcontroller, logic circuit, or other processing device. Processing system 630 may be distributed among multiple processing devices. User interface 660 may comprise a keyboard, mouse, voice recognition interface, microphone and speakers, graphical display, touch screen, or other type of user interface device. User interface 660 may be distributed among multiple interface devices. Storage system 640 may comprise a disk, tape, integrated circuit, RAM, ROM, EEPROM, flash memory, network storage, server, or other memory function. Storage system 640 may include computer readable medium. Storage system 640 may be distributed among multiple memory devices.

Processing system 630 retrieves and executes software 650 from storage system 640. Processing system 630 may retrieve and store data 670. Processing system 630 may also retrieve and store data via communication interface 620. Processing system 650 may create or modify software 650 or data 670 to achieve a tangible result. Processing system may control communication interface 620 or user interface 660 to achieve a tangible result. Processing system 630 may retrieve and execute remotely stored software via communication interface 620.

Software 650 and remotely stored software may comprise an operating system, utilities, drivers, networking software, and other software typically executed by a computer system. Software 650 may comprise an application program, applet, firmware, or other form of machine-readable processing instructions typically executed by a computer system. When executed by processing system 630, software 650 or remotely stored software may direct computer system 600 to operate as described herein.

Implementations discussed herein include, but are not limited to, the following examples:

### EXAMPLE 1

An integrated circuit, comprising: a plurality of last-level caches that include at least a first cache and a second cache, at least a first temperature sensor to generate a first temperature indicator that is associated with a temperature of the first cache; a plurality of processor cores to access data in the plurality of last-level caches according to a first hashing function that maps processor access addresses to at least the first cache and the second cache, wherein, based at least in part on the first temperature indicator, the plurality of processor cores are to access data in the plurality of last-level caches according to a second hashing function that maps processor access addresses to a subset of the plurality of last-level caches that does not include the first cache; and, an interconnect network to receive hashed access addresses from the plurality of processor cores and to couple each of the plurality of processor cores to a respective one of the plurality of last-level caches specified by the hashed access addresses generated by a respective one of the first and second hashing function.

### EXAMPLE 2

The integrated circuit of example 1, wherein the first cache is most tightly coupled with a first processor core and the second cache is most tightly coupled with a second processor core.

### EXAMPLE 3

The integrated circuit of example 2, wherein, based at least in part on a first processor temperature indicator that is associated with a temperature of the first processor, the plurality of processor cores are to access data in the plurality of last-level caches according to a second hashing function that maps processor access addresses to a subset of the plurality of last-level caches that does not include the first cache.

### EXAMPLE 4

The integrated circuit of example 3, wherein the plurality of processor cores are to stop accessing data in the plurality of last-level caches while contents of the first cache are transferred to the second cache.

### EXAMPLE 5

The integrated circuit of example 1, wherein the plurality of processor cores are to stop accessing data in at least the first cache while contents of the first cache are transferred to the second cache.

### EXAMPLE 6

The integrated circuit of example 5, wherein the plurality of processor cores are to also stop accessing data in the second cache while contents of the first cache are transferred to the second cache.

### EXAMPLE 7

The integrated circuit of example 5, wherein at least one processor core of the plurality of processor cores is to access data in a third cache of the plurality of last-level caches while contents of the first cache are transferred to the second cache.

### EXAMPLE 8

A method of operating a processing system having a plurality of processor cores, comprising: based at least in part on a first temperature indicator associated with a first cache of a first set of last-level caches of a plurality of last-level caches meeting a first threshold criteria, mapping, using a first hashing function, accesses by a first processor core of the plurality of processor cores to the first set of last-level caches; based at least in part on a second temperature indicator associated with the first cache of the first set of last-level caches of the plurality of last-level caches meeting a second threshold criteria, mapping, using a second hashing function, accesses by a first processor core to a second set of last-level caches that does not include the first cache.

### EXAMPLE 9

The method of example 8, wherein the first processor core is more tightly coupled to the first cache than to other last-level caches of the plurality of last-level caches and a second processor core is more tightly coupled to the second cache of the plurality of last-level caches.

### EXAMPLE 10

The method of example 9, wherein the second cache is in both the first set of last-level cached and the second set of last-level caches.

### EXAMPLE 11

The method of example 9, further comprising: based at least in part on a first processor temperature indicator associated with the first processor core meeting a first processor temperature criteria, mapping, using the first hashing function, accesses by the second processor core to the first set of last-level caches; and, based at least in part on a second processor temperature indicator associated with the first processor core meeting a second processor temperature criteria, mapping, using the second hashing function, accesses by the second processor core to the second set of last-level caches that does not include the first cache.

### EXAMPLE 12

The method of example 9, further comprising: before using the second hashing function to map accesses by the second processor core to the second set of last-level caches, stopping the accessing of data in the plurality of last-level caches.

### EXAMPLE 13

The method of example 12, wherein the accessing of data in the plurality of last-level caches is stopped while contents of the first cache are transferred to the second cache.

### EXAMPLE 14

The method of example 9, further comprising: before the first set of last-level caches use the second hashing function to map accesses to the second set of last-level caches, stopping the accessing of data in the plurality of last-level caches by the plurality of processor cores.

### EXAMPLE 15

An integrated circuit having a plurality of processor cores comprising: a first processor core to distribute, using a first hashing function, accesses by the first processor core to a first set of last-level caches of a plurality of last-level caches, the first processor core associated with a first last-level cache of the plurality of last-level caches; a second processor core to distribute, using the first hashing function, accesses by the second processor core to the first set of last-level caches, the second processor core associated with a second last-level cache of the plurality of last-level caches, wherein, based at least in part on a temperature indicator associated with at least one of second processor core and the second last-level cache, the first processor core is to distribute accesses by the first processor core to a second set of last-level caches using a second hashing function that does not map accesses to the second last-level cache.

### EXAMPLE 16

The integrated circuit of example 15, wherein, based at least in part on a temperature indicator associated with at least one of second processor core and the second last-level cache, contents stored in the second last-level cache are to be transferred from the second last-level cache to the first last-level cache.

### EXAMPLE 17

The integrated circuit of example 16, wherein all accesses to the first set of last-level caches are to be stopped while the contents stored in the second last-level cache are transferred to the first last-level cache.

### EXAMPLE 18

The integrated circuit of example 15, wherein, based at least in part on a temperature indicator associated with at least one of second processor core and the second last-level cache, contents stored in the second last-level cache are to be transferred from the second last-level cache to the second set of last-level caches.

### EXAMPLE 19

The integrated circuit of example 18, wherein all accesses to the first set of last-level caches are to be stopped while the contents stored in the second last-level cache are transferred to the second set of last-level caches.

### EXAMPLE 20

The integrated circuit of example 18, wherein after using the second hashing function that does not map accesses to the second last-level cache, and based at least in part on the temperature indicator associated with at least one of second processor core and the second last-level cache meeting a threshold criteria, the first processor core is to use the first hashing function to distribute accesses by the first processor core to the first set of last-level caches.

The foregoing descriptions of the disclosed embodiments have been presented for purposes of illustration and description. They are not intended to be exhaustive or to limit the scope of the claimed subject matter to the precise form(s) disclosed, and other modifications and variations may be possible in light of the above teachings. The embodiments were chosen and described in order to best explain the principles of the disclosed embodiments and their practical application to thereby enable others skilled in the art to best utilize the various embodiments and various modifications as are suited to the particular use contemplated. It is intended that the appended claims be construed to include other alternative embodiments except insofar as limited by the prior art.

What is claimed is:

1. An integrated circuit, comprising:
a plurality of last-level caches that include at least a first cache and a second cache, at least a first temperature sensor to generate a first temperature indicator that is associated with a temperature of the first cache;
a plurality of processor cores to access data in the plurality of last-level caches according to a first hashing function that maps processor access addresses to at least the first cache and the second cache, wherein, based at least in part on the first temperature indicator, the plurality of processor cores are to access data in the plurality of last-level caches according to a second hashing function that maps processor access addresses to a subset of the plurality of last-level caches that does not include the first cache; and,
an interconnect network to receive hashed access addresses from the plurality of processor cores and to couple each of the plurality of processor cores to a respective one of the plurality of last-level caches specified by the hashed access addresses generated by a respective one of the first and second hashing function.

2. The integrated circuit of claim 1, wherein the first cache is most tightly coupled with a first processor core and the second cache is most tightly coupled with a second processor core.

3. The integrated circuit of claim 2, wherein, based at least in part on a first processor temperature indicator that is associated with a temperature of the first processor, the plurality of processor cores are to access data in the plurality of last-level caches according to a second hashing function that maps processor access addresses to a subset of the plurality of last-level caches that does not include the first cache.

4. The integrated circuit of claim 3, wherein the plurality of processor cores are to stop accessing data in the plurality of last-level caches while contents of the first cache are transferred to the second cache.

5. The integrated circuit of claim 1, wherein the plurality of processor cores are to stop accessing data in at least the first cache while contents of the first cache are transferred to the second cache.

6. The integrated circuit of claim 5, wherein the plurality of processor cores are to also stop accessing data in the second cache while contents of the first cache are transferred to the second cache.

7. The integrated circuit of claim 5, wherein at least one processor core of the plurality of processor cores is to access data in a third cache of the plurality of last-level caches while contents of the first cache are transferred to the second cache.

8. A method of operating a processing system having a plurality of processor cores, comprising:
based at least in part on a first temperature indicator associated with a first cache of a first set of last-level caches of a plurality of last-level caches meeting a first threshold criteria, mapping, using a first hashing function, accesses by a first processor core of the plurality of processor cores to the first set of last-level caches; and,
based at least in part on a second temperature indicator associated with the first cache of the first set of last-level caches of the plurality of last-level caches meeting a second threshold criteria, mapping, using a second hashing function, accesses by a first processor core to a second set of last-level caches that does not include the first cache.

9. The method of claim 8, wherein the first processor core is more tightly coupled to the first cache than to other last-level caches of the plurality of last-level caches and a second processor core is more tightly coupled to the second cache of the plurality of last-level caches.

10. The method of claim 9, wherein the second cache is in both the first set of last-level cached and the second set of last-level caches.

11. The method of claim 9, further comprising:
based at least in part on a first processor temperature indicator associated with the first processor core meeting a first processor temperature criteria, mapping, using the first hashing function, accesses by the second processor core to the first set of last-level caches; and,
based at least in part on a second processor temperature indicator associated with the first processor core meeting a second processor temperature criteria, mapping, using the second hashing function, accesses by the second processor core to the second set of last-level caches that does not include the first cache.

12. The method of claim 9, further comprising:
before using the second hashing function to map accesses by the second processor core to the second set of last-level caches, stopping the accessing of data in the plurality of last-level caches.

13. The method of claim 12, wherein the accessing of data in the plurality of last-level caches is stopped while contents of the first cache are transferred to the second cache.

14. The method of claim 9, further comprising:
before the first set of last-level caches use the second hashing function to map accesses to the second set of last-level caches, stopping the accessing of data in the plurality of last-level caches by the plurality of processor cores.

15. An integrated circuit having a plurality of processor cores comprising:
a first processor core to distribute, using a first hashing function, accesses by the first processor core to a first set of last-level caches of a plurality of last-level caches, the first processor core associated with a first last-level cache of the plurality of last-level caches;
a second processor core to distribute, using the first hashing function, accesses by the second processor core to the first set of last-level caches, the second processor core associated with a second last-level cache of the plurality of last-level caches, wherein, based at least in part on a temperature indicator associated with at least one of second processor core and the second last-level cache, the first processor core is to distribute accesses by the first processor core to a second set of last-level caches using a second hashing function that does not map accesses to the second last-level cache.

16. The integrated circuit of claim 15, wherein, based at least in part on a temperature indicator associated with at least one of second processor core and the second last-level cache, contents stored in the second last-level cache are to be transferred from the second last-level cache to the first last-level cache.

17. The integrated circuit of claim 16, wherein all accesses to the first set of last-level caches are to be stopped while the contents stored in the second last-level cache are transferred to the first last-level cache.

18. The integrated circuit of claim 15, wherein, based at least in part on a temperature indicator associated with at least one of second processor core and the second last-level cache, contents stored in the second last-level cache are to be transferred from the second last-level cache to the second set of last-level caches.

19. The integrated circuit of claim 18, wherein all accesses to the first set of last-level caches are to be stopped while the contents stored in the second last-level cache are transferred to the second set of last-level caches.

20. The integrated circuit of claim 18, wherein after using the second hashing function that does not map accesses to the second last-level cache, and based at least in part on the temperature indicator associated with at least one of second processor core and the second last-level cache meeting a threshold criteria, the first processor core is to use the first hashing function to distribute accesses by the first processor core to the first set of last-level caches.
